(19) United States
(12) Patent Application Publication
(10) Pub. No.: US 2013/0073299 A1
(43) Pub. Date: Mar. 21, 2013

(54) CAREGIVING SOCIAL NETWORK

(71) Applicants: PAUL WARMAN, Alexandria, VA (US); Diane Ayres, Tallmadge, OH (US)

(72) Inventors: PAUL WARMAN, Alexandria, VA (US); Diane Ayres, Tallmadge, OH (US)

(73) Assignee: The Warman Group, LLC, Alexandria, VA (US)

(21) Appl. No.: 13/237,900

(22) Filed: Sep. 20, 2011

(51) Int. Cl. G06Q 50/00

(52) U.S. Cl. 705/2

(57) ABSTRACT

A server implements a caregiving social network dedicated to coordinating care between caregivers and care recipients. Profile information is recorded to assist in coordinating care, as well as targeting advertising and information material that is highly relevant to an individual user and his or her community. Users of the caregiving social network include seniors, disabled people, children, parents, volunteers, medical professionals, neighbors, military families, and pets. Users can maintain both a caregiver account to assist others, and a care recipient account for receiving assistance.

### BACKGROUND OF THE INVENTION

1. Field of Invention

The present invention relates generally to the field of social networks. More specifically, the present invention takes the concept of a social network and adds the element of purpose and social responsibility as it relates to care giving, both as a care giver and as a care recipient.

2. Discussion of Related Art

Social networks, such as Facebook®, have become popular tools for communicating with other people and organizations across the Internet. According to Experian® (March 2010), Facebook® hit an important milestone passing Google® to become the most visited site in the U.S. for the week. Hitwise, which samples Internet users and uses the sampled information for consultations with clients, recently noted that the market share of visits to Facebook was up as much as 185% from a comparable week from an earlier year. This is in stark contrast to Google's increase in market share, during the same time period, of only 9%.

The overall number of users associated with social networks has grown steadily, and is expected to continue growing as newer networks and features expand the reach of social networks. Current generation social networks suffer from a plurality of shortcomings. For example, they fail to address the need for bringing together the power of social networking and the need for family and community caregiving and support. Current generation social networks also fail to provide a web application that fully integrates, disseminates, organizes and mobilizes responsible care for users needing support for children, adults and even pets.

According to the Washington, D.C. U.S. Department of Health and Human Services: Office of Disability (Aging and Long-Term Care Policy, 2000), approximately 44 million American families and friends provide unpaid care to another adult, where such care is provided sometimes around the clock. Wives, daughters, sons, partners, fathers, nieces, brothers provide approximately 80% of the long-term care in the United States.

In 2002, more than one quarter (26.6%) of the adult population provided care for a chronically ill, disabled or aged family member or friend, which translates to more than 50 million people involved with caregiving. Studies have shown that:
about 37% of caregivers live in the same household as the person they care for;
about 54% of the people that are cared for are between 35 and 64 years of age;
about 59% of the adult population either is or expects to be a family caregiver, and
about 2 million more caregivers will be needed in the next twenty years.

Beginning Jan. 1, 2011 every single day, for the next 19 years, more than 10,000 Baby Boomers will reach the age of 65. Statistically, Baby Boomers are the largest generation in American history. They number approximately 77.6 million and control a significant amount of the wealth and spending power of the economy. As this generation enters retirement, the changes in their spending power are likely to generate a noticeable effect on the economy as a whole. Because of their numbers, they obviously play a very large role in politics, the economy, and the culture itself As Baby Boomers pass middle age, demands for geriatric medical care will increase and more strain is placed on entitlement programs such as Medicare and Social Security. Current generation social networks fail to provide a social resource for supporting what will become an overwhelming task on our entitlement system, and further fail to provide a manageable, safe, responsible way for family members, friends and volunteers to support those in need.

The number of people providing some type of care for another person will only increase with increasing longevity. Coordinating care between disconnected groups of family, friends, and other providers is often a disorganized combination of email, telephone calls, and messages passed back and forth. This is frustrating for the caregivers as well as the care recipients, and as the result is often a failure to meet the care requirement. There is a need to organize and mobilize the care of individuals through the medium of a social network.

The following references generally describe the prior art, but they fail to teach a system or method that organizes the care of individuals through the medium of a social network.

U.S. Pat. No. 6,640,212 attempts to coordinate the care for individuals in a group home setting by providing a standardized information system, which manages assigned tasks for residents and staff members.

U.S. Patent application publication 2010/0153287 provides for a self designed web site in support of a patient's needs. Friends and family are invited to access the site with login information that determines the access level to information and blogs concerning the patient.

The website www.lotsahelpinghands.com describes a portal for organizing support for a person in need. A user can create a community page and invite members to join the community. Tasks to support the person in need are created and emailed to the members of the community.

Embodiments of the present invention are an improvement over prior art systems and methods.

### SUMMARY OF THE INVENTION

The present invention, in one embodiment, provides a server that implements a caregiving social network by receiving a request to create a social network account, receiving at least one message with information relating to the owner of the account, creating the social network account with a profile containing information about the owner, and transmitting from the server a message acknowledging the creation of the account. The social network account is both a caregiver account and a care recipient account. The caregiver account allows the owner of the social network account to provide care for other care recipients, and the care recipient account allows the owner of the social network account to receive care from other caregivers.

In another embodiment, the present invention is a computer storage medium with computer readable program code that instructs a server to receive a request to create a social network account, receive a message with information relating to the owner of the account, create the social network account with a profile from the information relating to the owner of the account, and transmit an acknowledgement of the creation of the account. The social network account is both a caregiver account and a care recipient account. The caregiver account allows the owner of the social network account to provide care for other care recipients, and the care recipient account allows the owner of the social network account to receive care from other caregivers.

In a further embodiment, the present invention provides a server that receives a request to create a social network account for a first user, wherein the server receives at least one message with profile information, such as the name, age, gender, contact information, skills, limitations, likes and dislikes of the first user, and creates the social network account with a profile from the information provided. The server acknowledges the creation of the social network account. The server links the account of the first user to accounts of care recipients allowing the first user to provide care through a gateway. The server also links the account of the first user to accounts of caregivers allowing the first user to receive care through another gateway.

In some embodiments of the present invention, the social network may link together family members, friends, communities, pets, medical professionals, volunteers, and hired staff. The linked accounts can plan events for care recipients and request assistance from the care recipient's caregivers. The planned events may be one-off events, such as doctor's appointments or a vacation, or the event may be a recurring event, such as a weekly social gathering.

### BRIEF DESCRIPTION OF THE DRAWINGS

FIG. 1 illustrates an embodiment of the server system connected to its users.

FIG. 2 illustrates a flowchart for creating an account.

FIG. 3 illustrates a flowchart for linking an account to other accounts.

FIGS. 4A-C illustrate screenshots of the profile screen for care recipient and caregiver accounts.

FIG. 5 illustrates a screenshot of the care recipient gateway screen.

FIGS. 6A-F illustrate screenshots of the caregiver gateway screens.

FIG. 7 illustrates a screenshot of the medication information screen.

FIG. 8 illustrates a screenshot of the Activity Scheduler screen.

FIGS. 9A and 9B illustrate screenshots of the profile for child and pet subtypes of care recipients.

### DESCRIPTION OF THE PREFERRED EMBODIMENTS

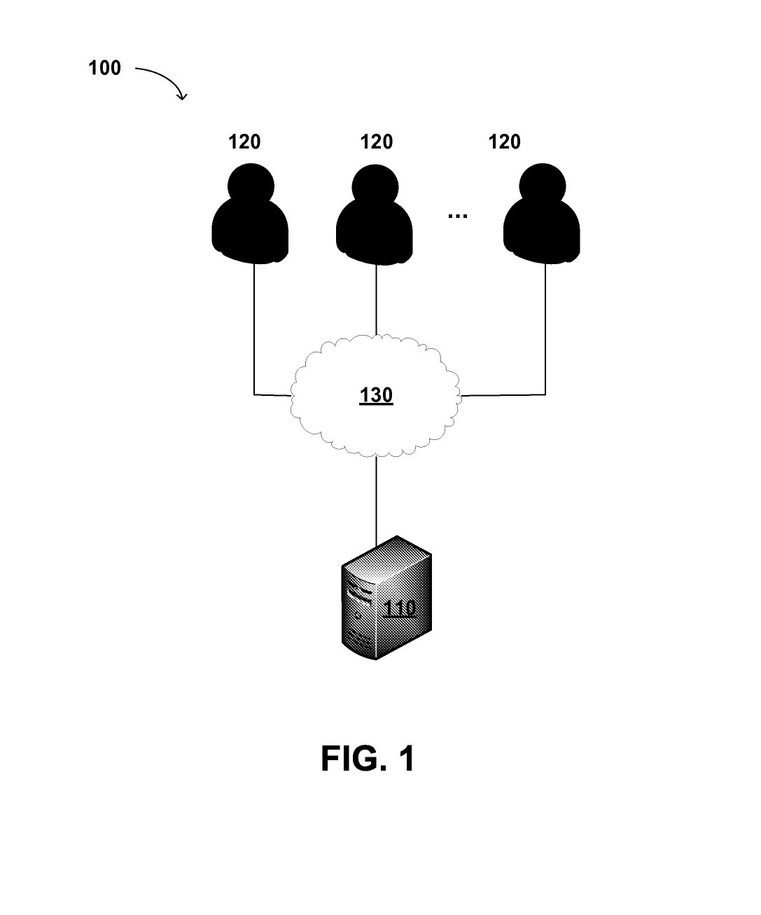

One goal of this invention is to provide assistance to anyone requiring it for a multitude of various reasons. Whether it be long term care to a disabled person, part time assistance to someone needing help coordinating transportation for their children to participate in afterschool activities, or helping someone take care of their family or pets in the event they have to leave town in an emergency. To address the problem of coordinating care between care recipients and disparate groups of caregivers, the present invention, as shown in FIG. 1, implements a web-based caregiving social network on a server 110 connected to a network 130, such as the Internet. While only one server and one network is depicted in FIG. 1, one of ordinary skill in the art may implement the present invention's web-based caregiving social network using a plurality of servers across a plurality of connected networks without departing from the scope of the present invention.

FIG. 1 shows a plurality of users 120 having accounts on the present invention's caregiving social network. Some of the users on the caregiving network provide care for other users within the same caregiving network. That is, one user of the caregiving network can be a care provider, while another user of the caregiving network may be a care recipient. For example, users can be care givers to senior or disabled family members/friends, who are also users of the present invention's caregiving network. Similarly, users, as part of a volunteer or professional service, may assist with senior care, disabled care, or child care. Additional non-limiting examples of how users may use the present invention's caregiving network to help other users include: providing care for military families with deployed members, providing services to accommodate parents who shares resources with other users in order to manage their children's extracurricular activities, and providing services to friends or family of pet owners who have become incapacitated and are unable to care for their pets. Additionally, users may include care recipients such as seniors who require assistance, disabled or incapacitated individuals who require assistance, children who require supervision or transportation, parents with school age children, military families who have a parent deployed, volunteer organizations, and pet owners who may become incapacitated.

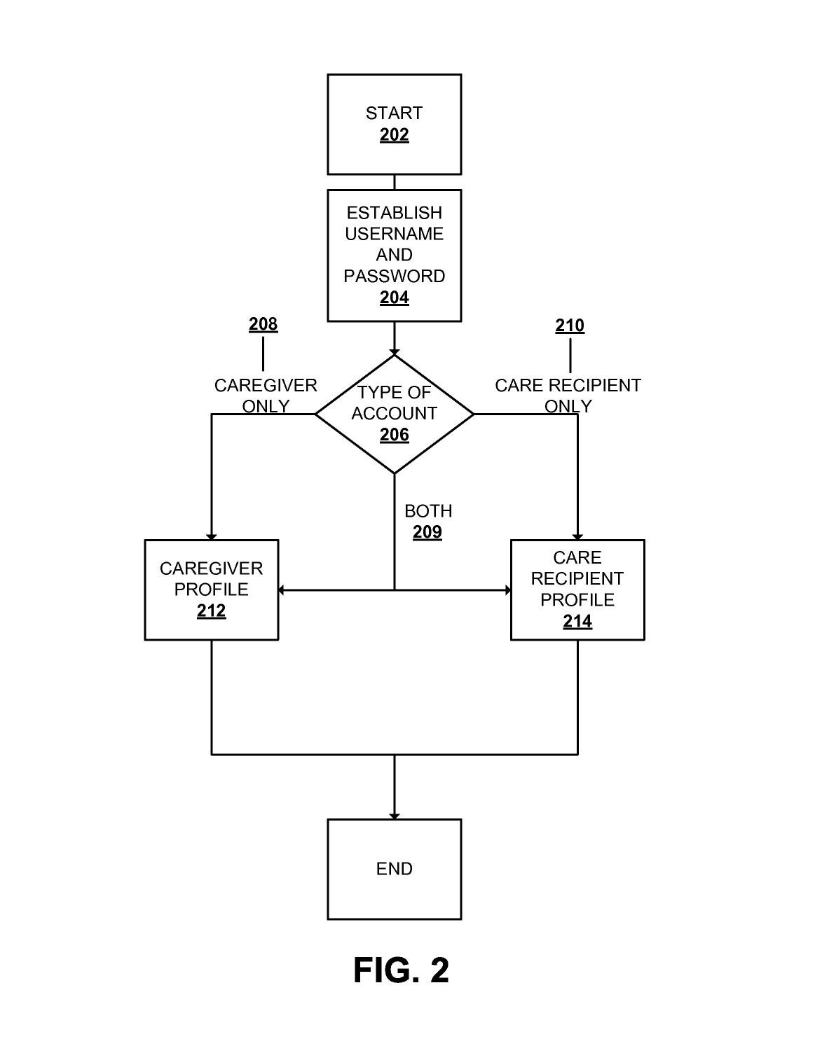

FIG. 2 depicts a flow chart outlining the steps involved in creating an account on the present invention's caregiving social network. In step 202, a primary user or owner sends a request to create an account on the present invention's caregiving social network.

In step 204, the owner establishes a username and password to associate with the account, and in step 206, a choice is made as to whether the account will be a caregiver account 208, a care recipient account 210, or both 209. Based on the choice of account(s), a caregiver profile 212 and/or a care recipient profile 214 is generated. Most users will want to have both their caregiver and care recipient profiles completed.

It should be noted that just because a user has a disability, he/she is not necessarily exempt from being a caregiver. For example, a disabled person having only a physical disability could still be a caregiver as they are still able to make phone calls to check up on elderly incapacitated persons.

Further, using the present invention's caregiving social network, users who are usually caregivers can set up a request seeking services from other caregivers. For example, someone with a family and/or pets who primarily participate in the caregiving social network as a caregiver may be unable to fulfill his/her duties as a caregiver (e.g., if he/she has to fly out of town with no notice to be with an ill friend or family member). In this instance, such a user would be able to send an activity request for their own purposes seeking other users who may become his caregivers. In this example, the care recipient profile information is completed by that user (that identifies task(s) that the travelling user may need assistance with) and made available to his/her supporters on the caregiver social network and someone could step in to assist immediately. It should be noted that in the preferred embodiment, a user can only be a caregiver by accepting an invitation from a care recipient account.

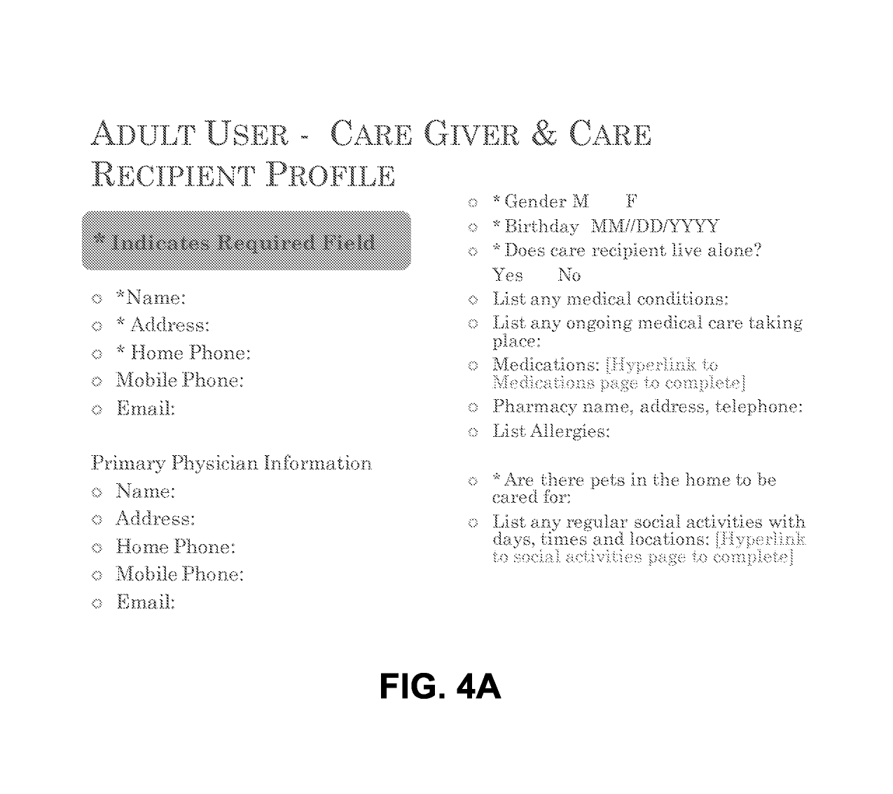

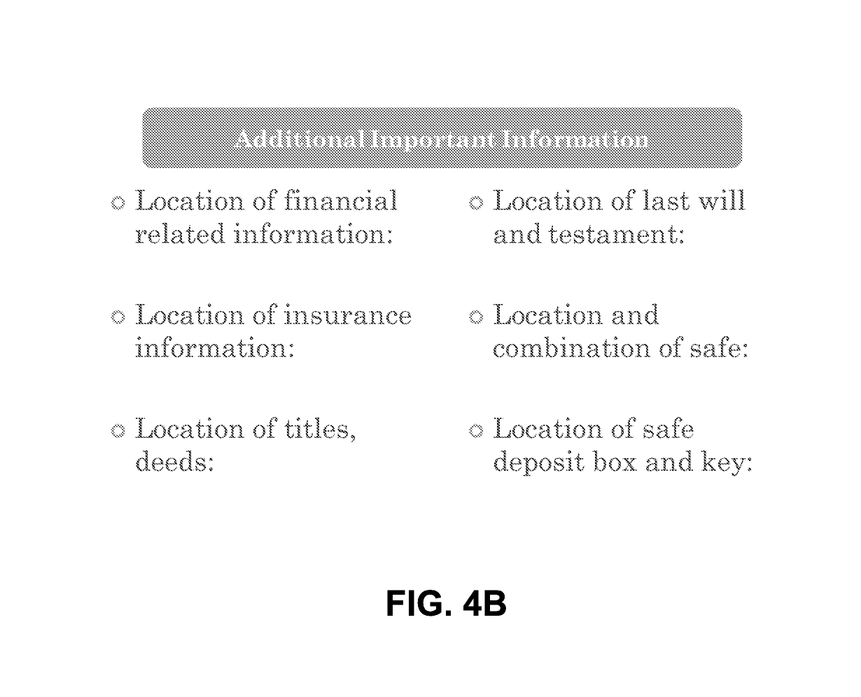

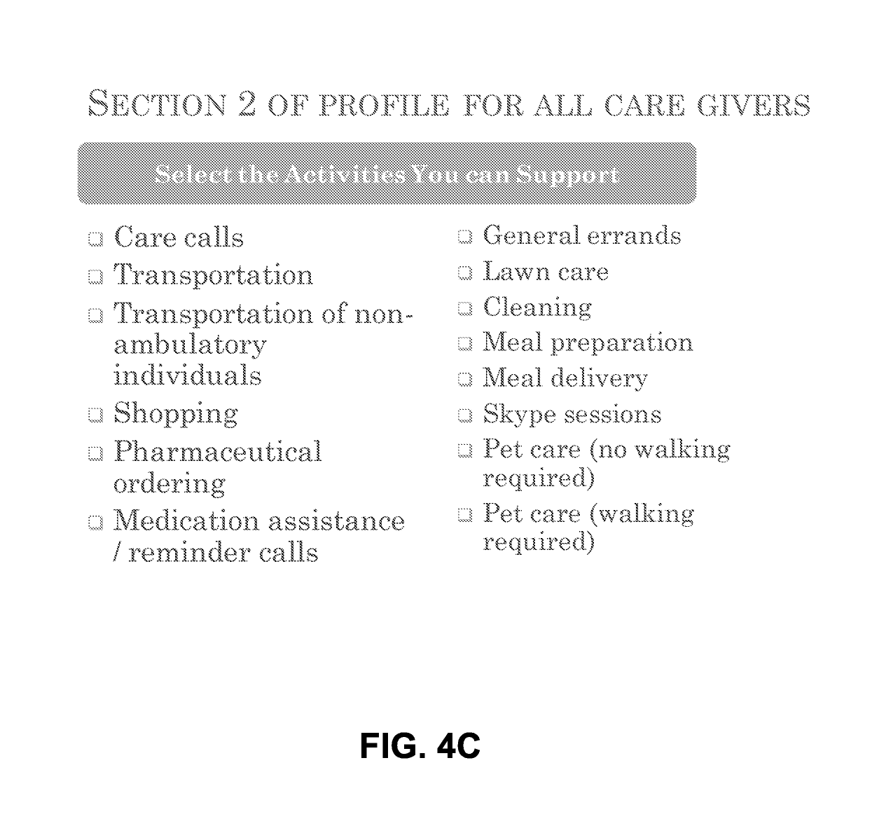

The two types of accounts (i.e., caregiver or care recipient) also differ in the information provided in the respective profiles, as shown in FIG. 4A through 4C. After the type of account is established, information to populate a profile of the owner is sent to the server. Some information, such as name, age, gender, birth date, and contact information is common to both types of accounts. Information can also be unique to the type of account, as information that may be useful for a caregiver account may not be particularly useful with regards to the care recipient account.

FIG. 4A shows a non-limiting example of profile information that is common to both caregiver and care recipient profiles. FIG. 4B shows additional profile information that may be filled out with regards to a care recipient profile, wherein this care recipient profile may be accessed and used by some of the care recipient's caregivers. Care recipient profiles are designed to provide information (e.g., information about the care recipient) that may be required by a care provider in order to step in and provide care immediately.

FIG. 4C shows a non-limiting example of profile information from a caregiver's profile, wherein the caregiver's profile lists what support the caregiver is willing to provide. This information in the profile allows the caregiver to select whether or not they are willing and/or able to assist with each type of request. This streamlines the process by preventing inappropriate requests from going to the support community and therefore discouraging their desire to participate in the caregiver social network community.

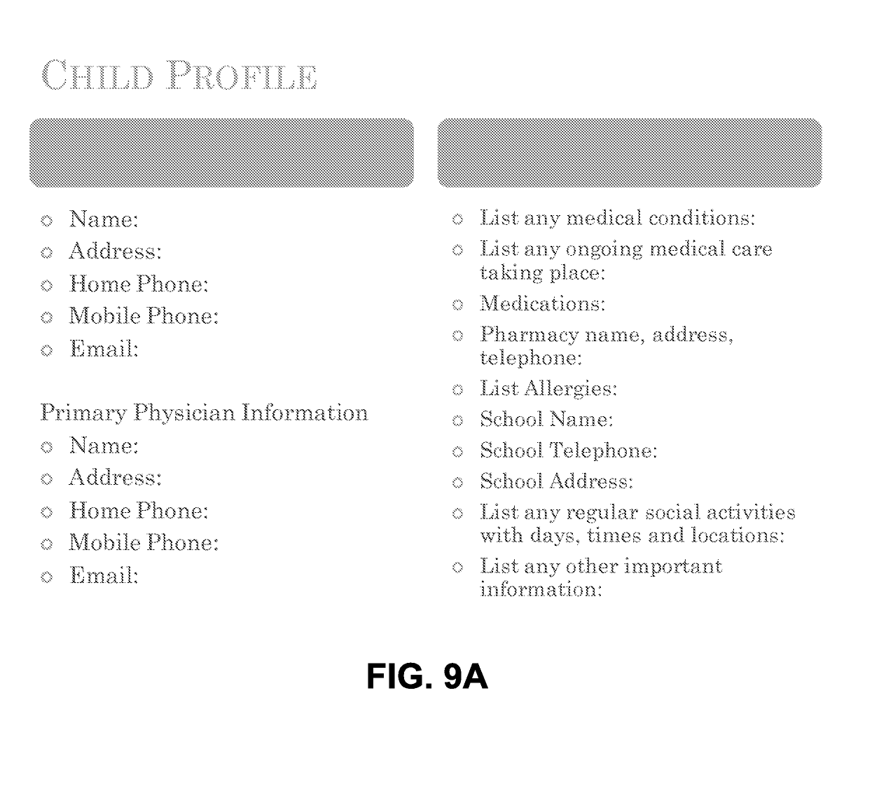

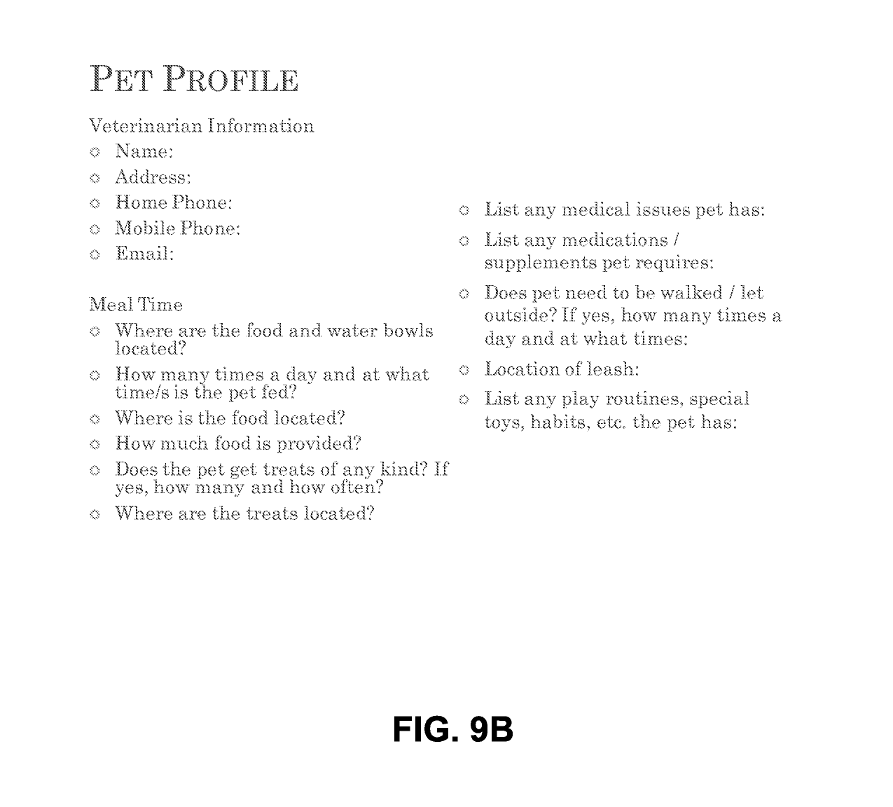

In one embodiment, care recipient accounts may be further classified in sub-types, such as pet, child, or senior citizen. FIG. 9A and FIG. 9B show exemplary profile information for care recipient accounts with sub-types of a child and a pet, respectively. In another embodiment, caregiver accounts may be further classified into sub-types, such as family, medical practitioner, or volunteer.

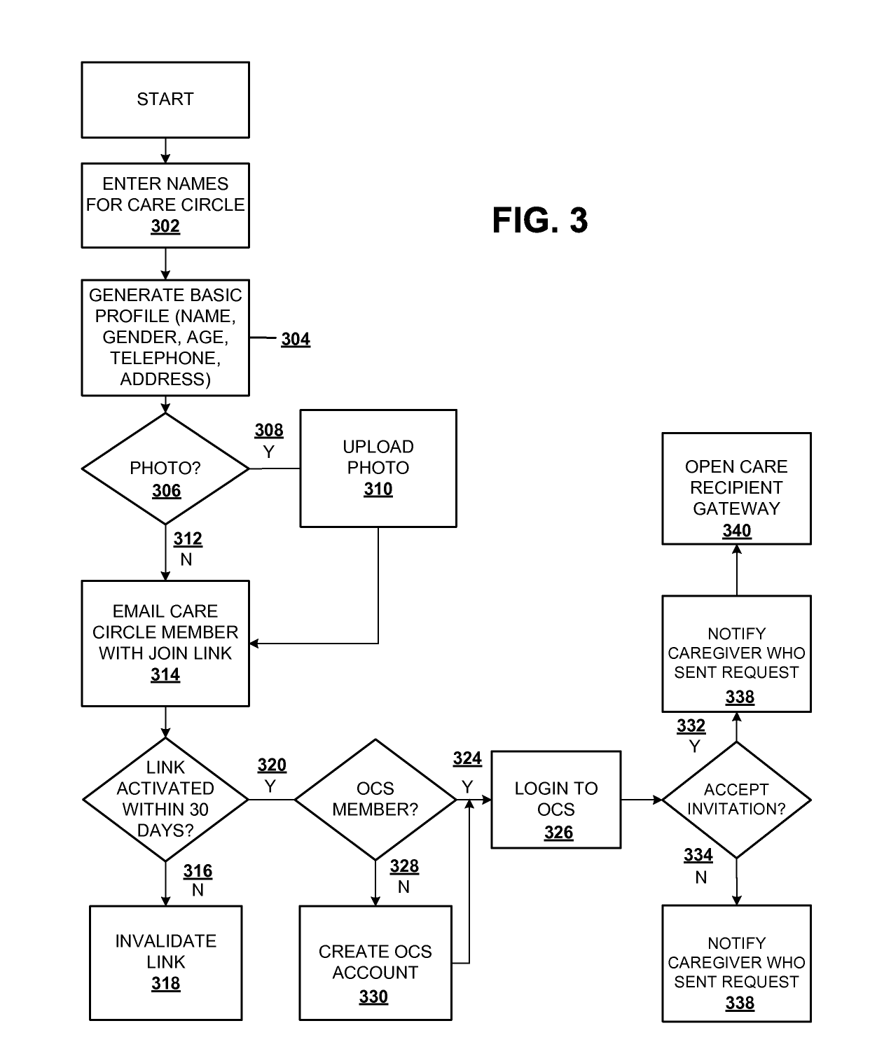

After the owner creates his or her account and receives an acknowledgement that the account has been created, the owner can begin to create his or her “Care Circle”, or circle of supporters, as well as link to any other accounts that the owner has been invited to support. FIG. 3 shows the steps for linking an owner's account to other people. In step 302, the owner lists the names that are to be part of his or her Care Circle and, in step 304, the owner develops a basic profile with information such as, but not limited to: name, gender, age, telephone numbers, and addresses. In step 306, the owner indicates if he/she has a photograph of the people being invited to be part of his or her Care Circle. If there are photographs 308, the owner uploads them to the server in step 310 and associates them with a particular individual in his or her Care Circle. Once the photographs are uploaded 310 or, in case there are no photographs 312, the server emails all of the individuals in the Care Circle inviting them to join as a caregiver for the owner 314. The invitation includes a link to activate the caregiver account in the present invention's caregiver social network. If the link is not used within a predetermined time (e.g., 30 days) 316, the link is rendered inactive 318. If the link is active 320, a check 322 is made to see if the supporter is already a member of the present invention's caregiver social network and, if so 324, the supporter is asked to login 326. If the supporter is not a member of the present invention's caregiver social network 328, the supporter is asked to create a new account in step 330, wherein after the creation of the account, the supporter is asked to login 326. After logging in to present invention's caregiver social network, the supporter can accept 332 or decline 334 the invitation to become a caregiver to the care recipient. If the supporter accepts invitation 332, the owner of the care recipient account is notified in step 336. The owner of the care recipient account is also notified in step 338 if the supporter declines the invitation 334. When the supporter accepts the invitation to become a caregiver, he or she is taken to the care recipient's gateway in step 340 and is able to interact as a caregiver for the care recipient.

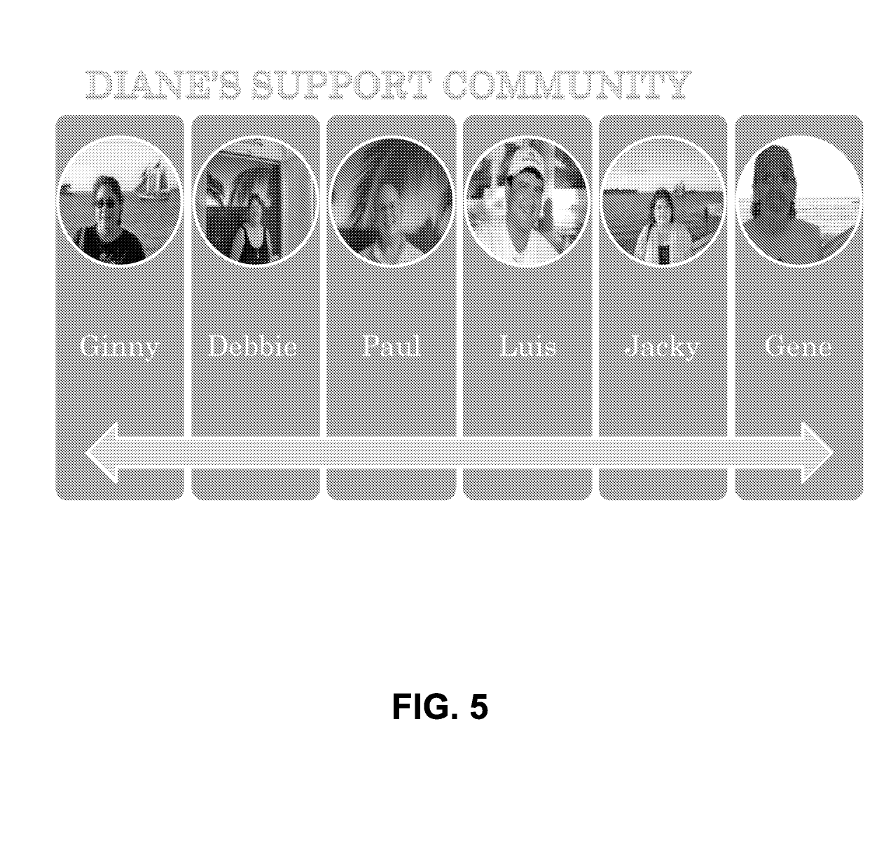

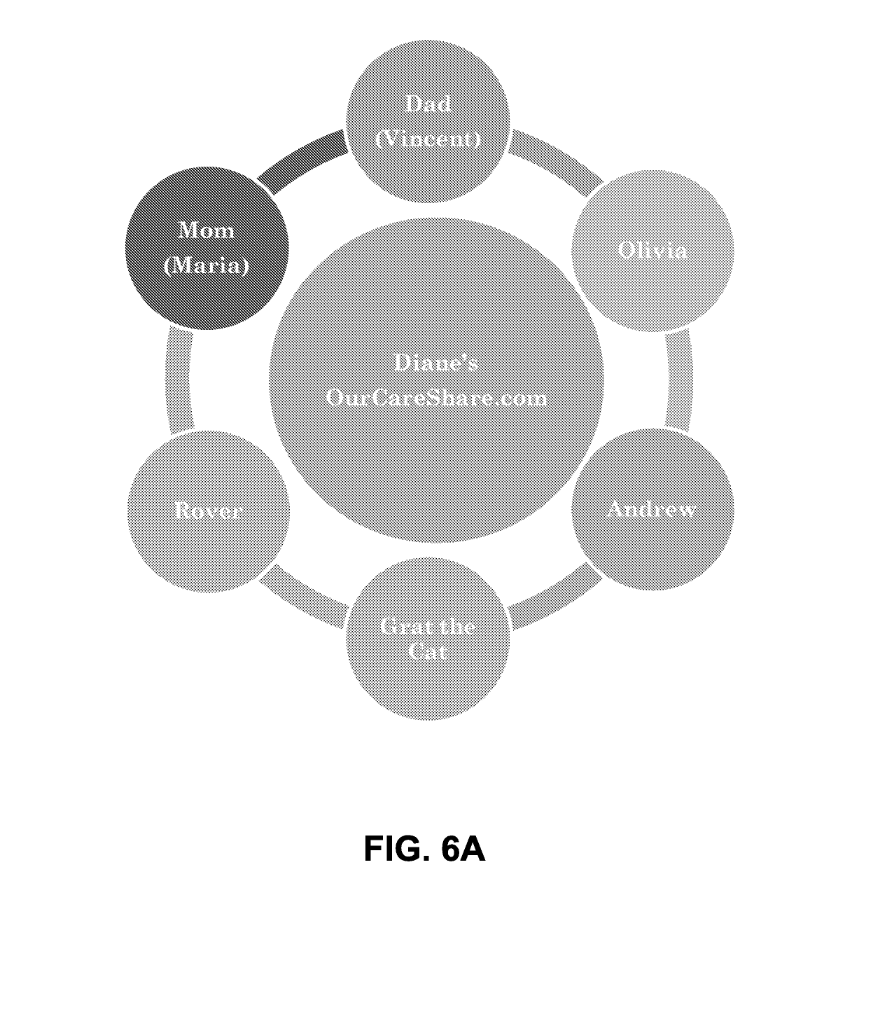

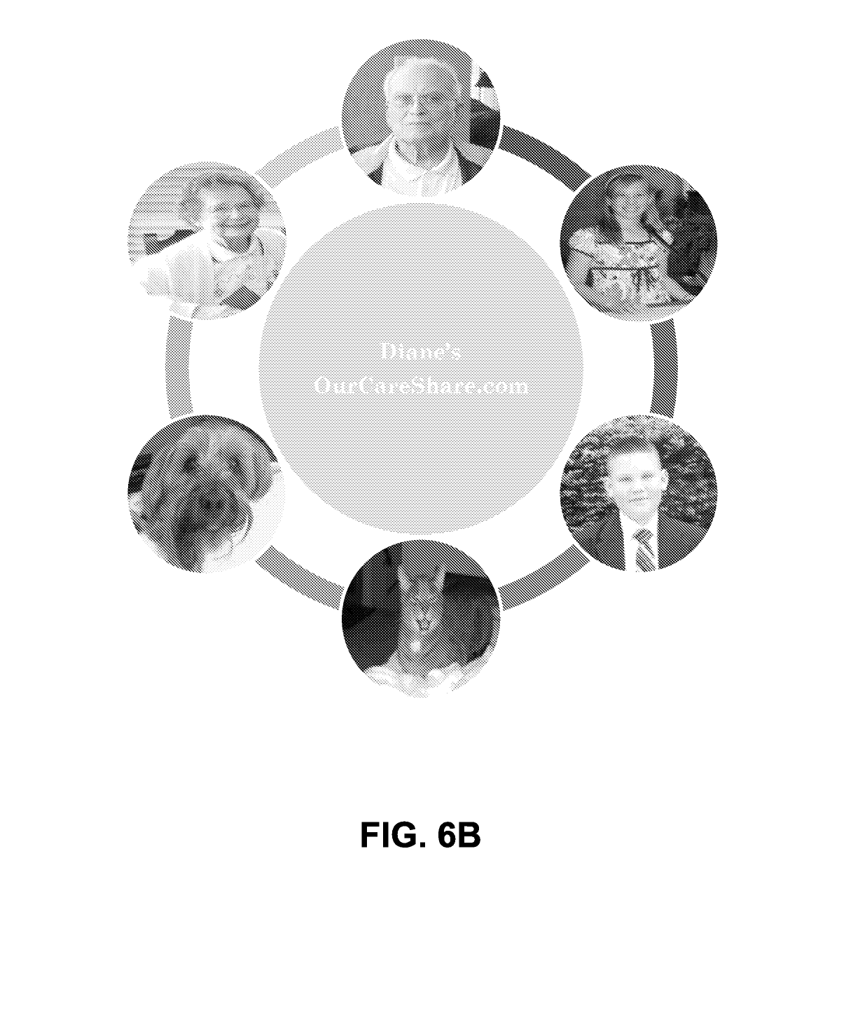

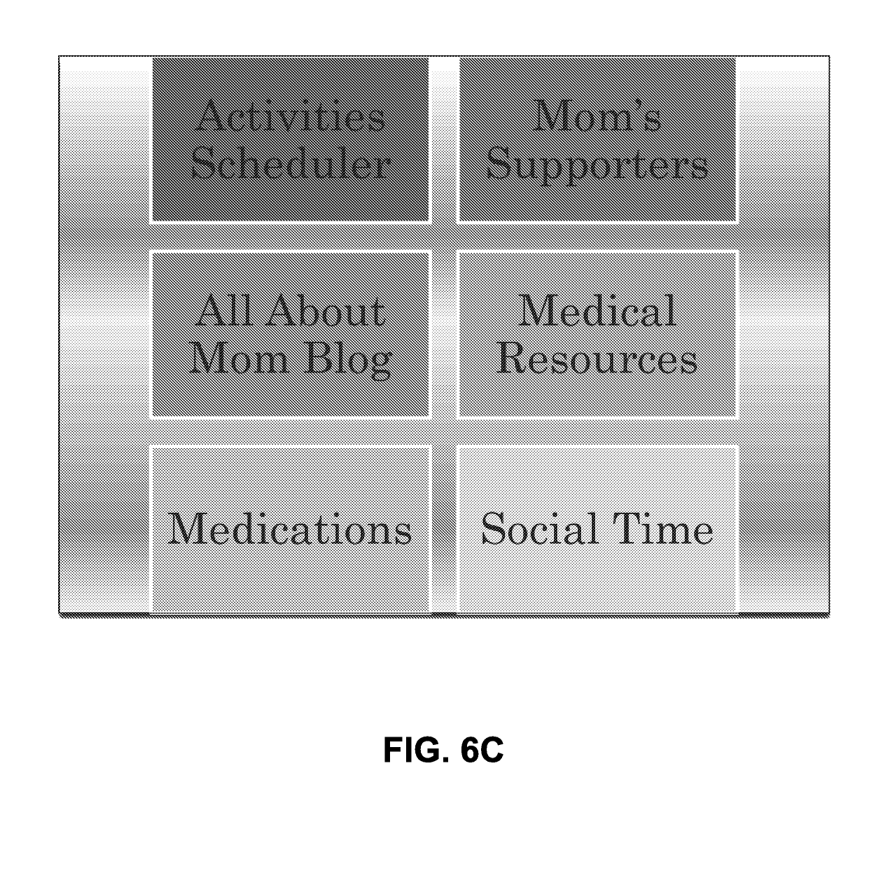

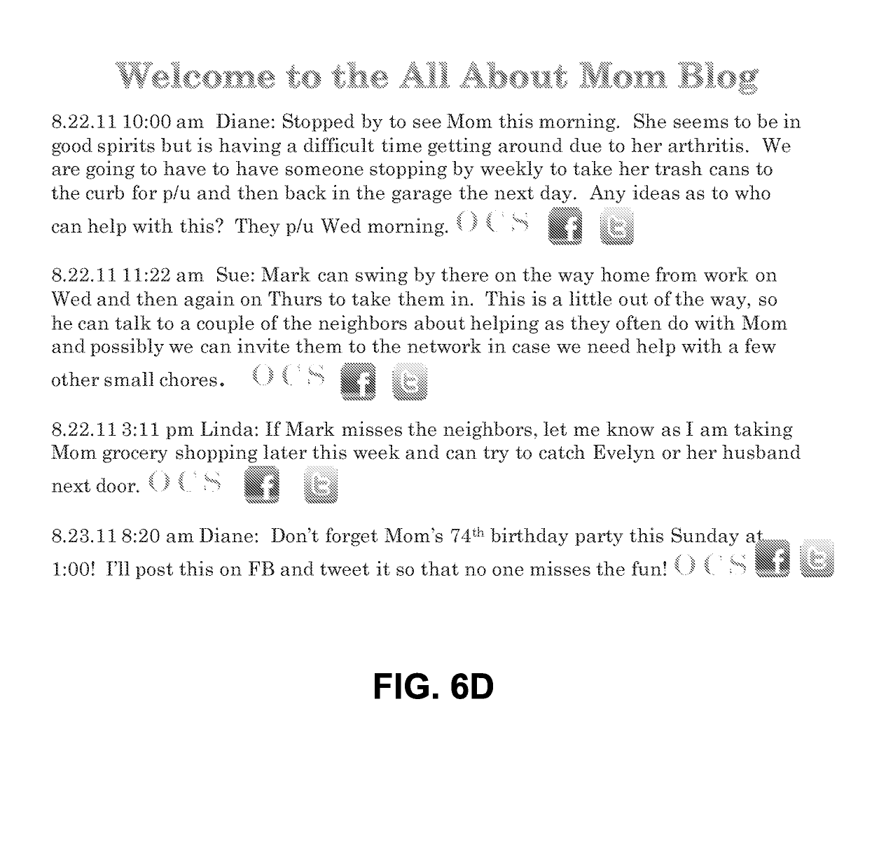

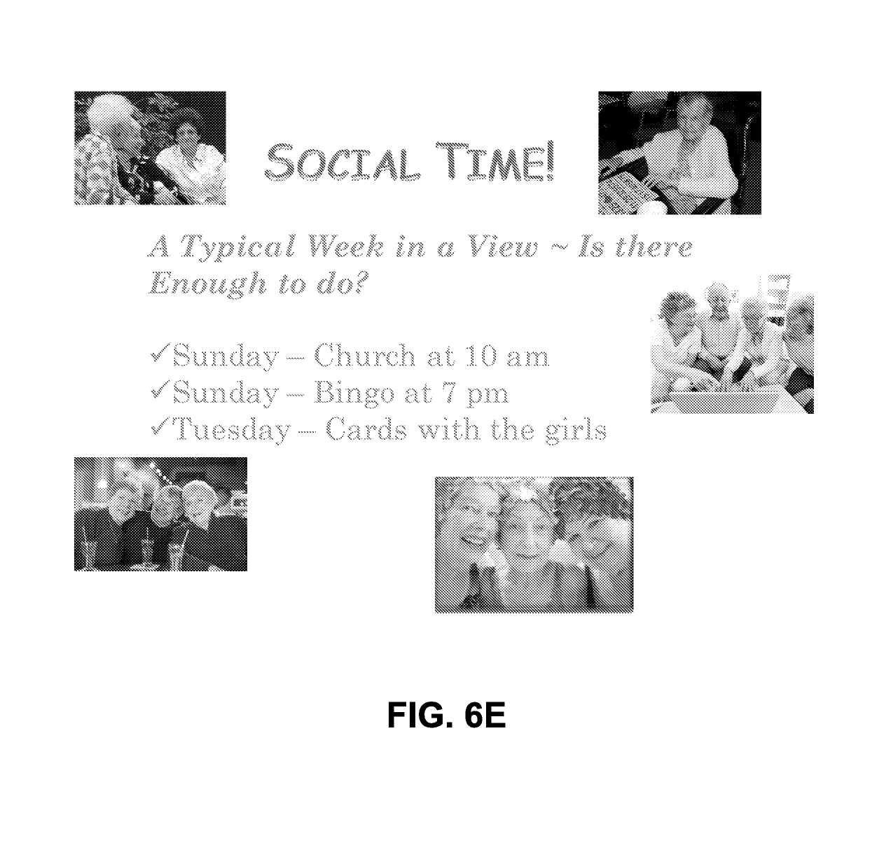

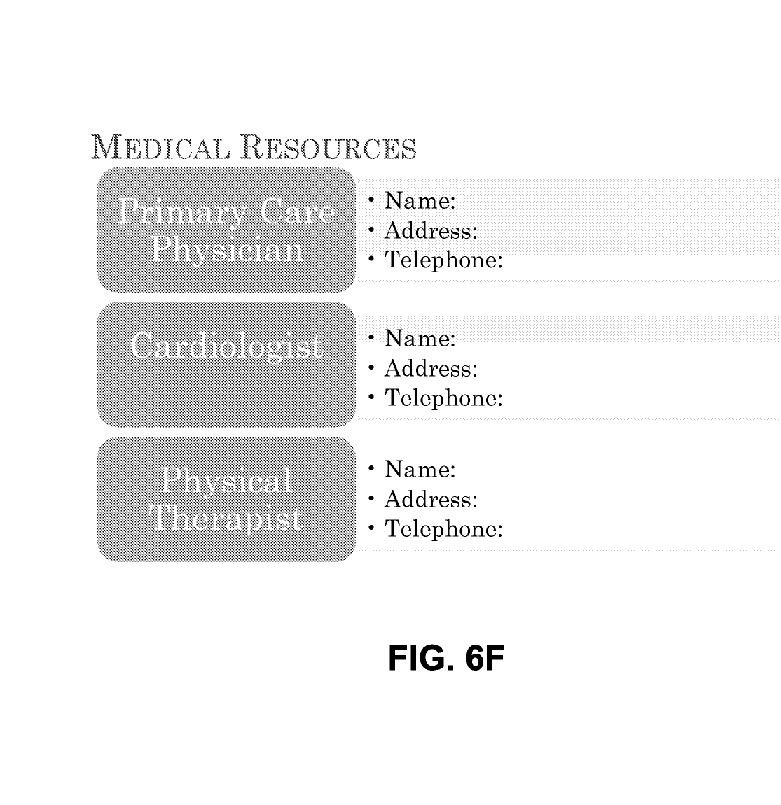

Upon logging in to present invention's caregiver social network, caregivers see all of the care recipients that they support. FIGS. 6A and 6B depict exemplary screenshots of the gateway. If they also have a care recipient profile set up, they can see a list of their caregivers. FIG. 5 shows an exemplary screenshot of a care recipient's support community. A caregiver also sees their activity scheduler, community blog, and message center. Through the proper gateway, a user can also see the activity scheduler and community blog for any care recipient for which the user provides care. FIG. 6C shows an example of the gateway for a care recipient (Mom), through which a caregiver can access and coordinate care for the care recipient. FIG. 6D shows one example of a care recipient's blog that is accessed by caregivers. Postings on the blog may be directed to all OCS users in the community, all caregivers, all care recipients, or some other subset of the OCS community. The message center is an inbox where all messages and activity requests are directed. A copy of the messages and activity requests may also be sent to a personal email address provided in the user's profile. FIG. 6E shows an example of a care recipient's social activities, which a caregiver can access to make sure that the care recipient is maintaining social ties. FIG. 6F shows an example of a care recipient's medical contact information that can be used by a support community member. A support community member can also access an option to add a care recipient to his or her community, as well as an option to request that a new supporter join as a caregiver to any of his or her care recipients. The request may be to join as a caregiver to specific care recipients, or the request may leave the option to assist any of the user's care recipients.

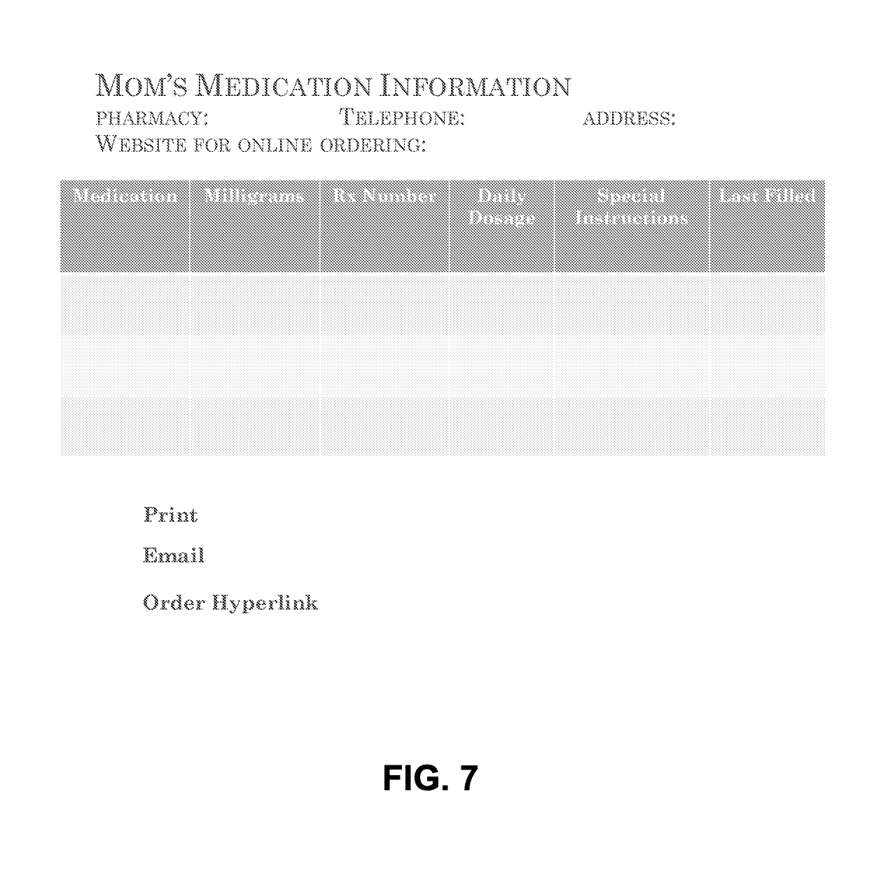

FIG. 7 shows a care recipient's medication information, which can be accessed by a caregiver with the proper level of authorization. This gives authorized caregivers immediate access to crucial pharmaceutical information when the care recipient is not able to provide that information. The care recipient can also print out the information to take to a doctor's appointment to ensure that everything is being taken as prescribed. If the care recipient's pharmacy has the option to order refills online, this interface can be added to the OCS site. Due to the sensitive nature of some of the information on account profiles, some caregiver accounts may have access granted or restricted based on their need to know elements of the profile. A neighbor who provides support by occasionally pet sitting does not need to know the types of medicine that the pet's owner takes, but might need to know where a spare key to the house is hidden. Conversely, a pharmacist does need to know the medicines that the care recipient takes, but does not need to know where a spare key is located. Access to every piece of information in an account owner's profile is controllable in several levels of granularity. Whoever actually establishes the care recipient on OCS will be the primary administrator for that care recipient and will be responsible for updating their profile information as necessary for the caregivers. When granting a higher level of access to any caregiver, the primary administrator will receive a notification asking if they are certain they want to proceed with the request, for security purposes. They can also establish other administrators for the care recipient to assist in this process. These administrators would also have a level of security assigned to them which would encompass their ability to see more sensitive information.

After the caregiving social network account is created and linked to other caregivers and/or care recipients, account owners can use the social network to post information about a care recipient that all of that person's supporters can see. A care recipient who is fighting a chronic disease may post a blog to keep his or her supporters up to date.

A key differentiator and ultimate revenue/funding source for the site is the ability for advertisers to select specific areas/pages of the site to post their advertising message, article, coupons and the like. Due to the detailed profiles and site categories of care givers and recipients, advertising can be highly targeted driving more applicable information to the site users and greater value to advertisers. Users can access information concerning important topics associated with the care recipients in their network, since the topics are filtered by data from the profiles. Users can also be presented with products that may be useful to them or to people in their network, since advertising can be filtered by data from the profiles. When a user is visiting sections of OCS for those that they support at any level, they will see advertising and informational articles appropriate to the age and gender group or type of pet that they are supporting. When a user is working within their own gateway, they will see ads and information articles appropriate to their own age and gender group. Additionally, supporters may be presented with targeted information and advertisements based on the profile of the care recipients that they are linked to. Some of the information stored in a user's profile can be automatically updated to provide the most targeted advertising and informational articles. For example, all age information on profiles will progress one year annually on the date of birth. This will ensure targeted advertising and information are based on current age instead of the age entered when the account was created.

Another use for the social network is coordinating help for care recipients with events in their life, such as doctor's appointments or social opportunities. Either the care recipient or a supporter creates an event on a calendar, which is shared with all of the care recipient's supporters. If the care recipient requires assistance for the event, a request is sent to some or all of the care recipient's supporters. Caregivers can choose to filter the requests they receive according to their profile. For example, if a caregiver does not have a car, they can choose to filter out any request that would require the use of a car, such as a doctor's appointment. The benefit of this feature is that by filtering out the requests which the care giver is not willing or able to perform for any reason, they only receive valid activity requests and therefore understand they need to open and review each request they receive. This makes the support community much more effective.

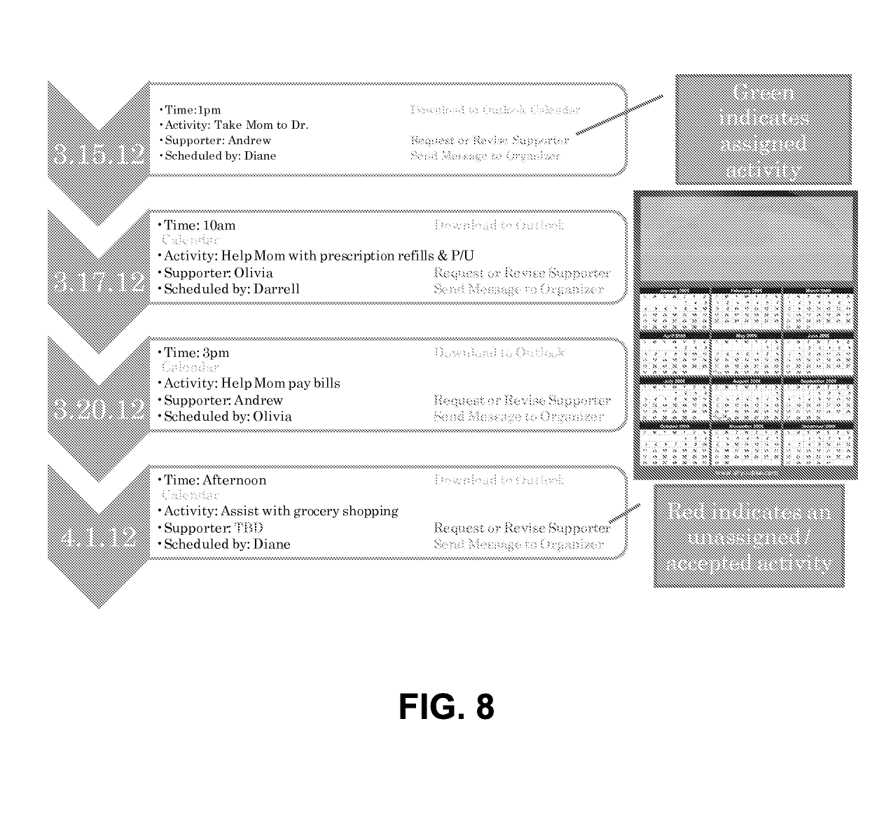

FIG. 8 shows an exemplary screenshot of a care recipient's calendar with events on it. Since a caregiver may have their own calendar with their own events planned on it, the social network provides for merging an accepted request for assistance from the care recipient's calendar to the caregiver's calendar.

With a social network account that is both a caregiver and a care recipient account, dependencies may also be introduced to make sure that the owner's caregivers take care of the owner's care recipients if the owner is incapacitated. For example, an elderly person may have several caregivers, as well as having responsibility for a care recipient such as a pet. In the event that the elderly person is incapacitated for an extended period of time, the person's caregiver circle is notified that someone needs to provide care for the pet. The caregivers at an administrative level will be those who would generally review the profile of the care recipient to ensure pets are taken care of appropriately if someone is taken to a hospital or is otherwise away from their residence. They have assisted the care recipient in setting up the profile and most likely know the pet requires care. They can then go into the OCS and request care from the care recipient's community. An alternative embodiment creates a “status” listing which identifies that the care recipient is not at home and automatically sends alerts to the care recipient's support community.

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Additionally, the present invention provides for an article of manufacture comprising computer readable program code contained within implementing one or more modules to implement a caregiving social network. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for:
(a) receiving a request to create a social network;
(b) receiving at least one message comprising information relating to an owner of the social network account;
(c) creating a social network account with a profile comprising the information relating to the owner of the social network account; and
(d) transmitting a message acknowledging the creation of the account;

### Conclusion

A system and method has been shown in the above embodiments for the effective implementation of a Caregiving Social Network. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (e.g., CRT, LCD, etc.) and/or hardcopy (e.g., printed) formats. The programming of the present invention may be implemented by one having ordinary skill in the art of social networks.

1. A system comprising a server with a processor and storage, said storage storing computer readable program code that is executed by the processor to implement a caregiving network on the server, said storage comprising:
computer readable program code executed by the processor to receive a request to create a social network account;
computer readable program code executed by the processor to receive at least one message comprising information relating to an owner of the social network account;
computer readable program code executed by the processor to create the social network account with a profile comprising the information relating to the owner of the social network account;
computer readable program code executed by the processor to transmit from the server a message acknowledging the creation of the social network account;
wherein the social network account is both a caregiver account and a care recipient account;
wherein the caregiver account provides a first gateway for the owner of social network account to provide care for at least one care recipient;
wherein the care recipient account provides a second gateway for the owner of the social network account to receive care from at least one caregiver.

2. The system of claim 1, wherein the information relating to the owner of the social network account comprises at least one of: gender, age, contact information, skills, limitations, likes, or dislikes.

3. The system of claim 1, wherein the social network account is linked to a plurality of other accounts on the server.

4. The system of claim 3, wherein the plurality of other accounts are accounts that belong to at least one of: a family member, a friend, a community member, a neighbor, a pet, a volunteer, or hired staff

5. The system of claim 1, said storage further comprising:
computer readable program code executed by the processor to receive a first request for an event for the owner of the social network account;
computer readable program code executed by the processor to transmit from the server a second request to at least one caregiver account for assistance with the event;
wherein the second gateway organizes information relating to the event for the owner of the social network account.

6. The system of claim 5, wherein the event is a recurring event, and said storage comprises computer readable program code executed by the processor to transmit further requests to the at least one caregiver account for assistance with each occurrence of the event.

7. The system of claim 5, wherein the event is one of: a social activity, a planned vacation, or a doctor's appointment.

8. The system of claim 1, wherein the request to create the social network account is not sent by the owner of the social network account.

9. An article of manufacture comprising a computer storage medium with computer implementable program code that instructs a server to:
receive a request to create a social network account;
receive at least one message comprising information relating to an owner of the account;
create the social network account with a profile comprising the information relating to the owner of the account;
transmit a message acknowledging the creation of the account;
wherein the account is both a caregiver account and a care recipient account;
wherein the caregiver account provides a gateway for the owner of caregiver account to provide care for at least one care recipient;
wherein the care recipient account provides a second gateway for the owner of the care recipient account to receive care from at least one caregiver.

10. The article of manufacture of claim 9, wherein the information relating to an owner of the account comprises at least one of: gender, age, contact information, skills, limitations, likes, or dislikes.

11. The article of manufacture of claim 9, wherein the account is linked to a plurality of other accounts on the server.

12. The article of manufacture of claim 11, wherein the plurality of other accounts are accounts that belong to at least one of: a family member, a friend, a community member, a neighbor, a pet, a volunteer, or hired staff.

13. The article of manufacture of claim 9, said storage further comprising computer implementable program code that instructs a server to:
receive a first request for an event for the owner of the social network account;
transmit a second request to at least one caregiver account for assistance with the event;
wherein the second gateway organizes information relating to the event for the owner of the social network account.

14. The article of manufacture of claim 13, wherein the event is a recurring event, and said storage comprises computer readable program code executed by the processor to transmit further requests to the at least one caregiver account for assistance with each occurrence of the event.

15. The article of manufacture of claim 9, wherein the request to create the social network account is not sent by the owner of the account.

16. A system comprising a server with a processor and storage, said storage storing computer readable program code that is executed by the processor to implement a caregiving network on the server, said storage comprising:
computer readable program code executed by the processor to receive a request to create a social network account for a first user;
computer readable program code executed by the processor to receive at least one message comprising a name, age, and gender of the first user, contact information for the first user, skills and limitations of the first user, and likes and dislikes of the first user;
computer readable program code executed by the processor to create the social network account with a profile comprising the contents of the at least one message;
computer readable program code executed by the processor to transmit an acknowledgement of the creation of the account;
wherein the account for the first user is linked to a plurality of care recipient accounts of a plurality of second users, and the account for the first user is linked to a plurality of caregiver accounts of a plurality of third users;
wherein the plurality of caregiver accounts provide gateways for the plurality of third users to provide care for the first user; and
wherein the plurality of care recipient accounts provide gateways for the plurality of second users to receive care from the first user.

17. The system of claim 16, said storage further comprising:
computer readable program code executed by the processor to receive at the a first request for an event for the first user;
computer readable program code executed by the processor to transmit a second request for assistance with the event to at least one of the plurality of caregiver accounts of the plurality of third users.

18. The system of claim 16, wherein the request to create the social network account is not sent by the owner of the social network account.
